(19) United States
(12) Patent Application Publication
(10) Pub. No.: US 2015/0226868 A1
(43) Pub. Date: Aug. 13, 2015

(54) METHOD FOR MICROSEISMIC EVENT MOMENT MAGNITUDE ESTIMATION

(71) Applicant: Microseismic, Inc., Houston, TX (US)

(72) Inventors: Robert Cieplicki, Kielce (PL); Leo Eisner, Praha (CZ)

(73) Assignee: Microseismic, Inc., Houston, TX (US)

(21) Appl. No.: 14/176,165

(22) Filed: Feb. 10, 2014

(51) Int. Cl. G01V 1/30

(52) U.S. Cl. CPC G01V 1/307

(57) ABSTRACT

A method for estimating moment magnitude of a seismic event occurring in subsurface formations includes measuring seismic signals at each of a plurality of seismic sensors disposed in a selected pattern proximate a subsurface area in which the seismic event occurs. Amplitude events corresponding to the seismic event from the signals detected by each receiver are time aligned. Corrections are applied to the aligned events for density, for the formation velocity, for the radiation pattern, for propagation effects and instrument response. The corrected events are summed. Seismic moment is determined from the summed, corrected events. A moment magnitude is estimated from the seismic moment.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND

This disclosure is related to the field of evaluation of seismic events occurring in the subsurface (“microseismic events”). More specifically, the disclosure relates to methods for estimating moment magnitude of such microseismic events.

Microseismic monitoring of hydraulic fracturing is used by field operators for completion evaluation, reservoir characterization and hazard avoidance. As microseismic technology matures, microseismic events induced by fracturing are no longer described simply as “dots in a box”, i.e., single point indications of the location of the microseismic events, but discrete fracture networks (DFN) are generated from analysis which may be used for stimulated reservoir volume (SRV) estimation (See, e.g., Eisner L., Williams-Stroud S., Hill A., Duncan P., and Thornton M., Beyond the dots in the box: microseismicity-constrained fracture models for reservoir simulation, The Leading Edge, 29(3), 326-333, 2010) DFNs and SRVs are benchmarked by modeling flow in hydraulically fractured reservoirs and estimating fluid production from them (See, e.g., Williams-Stroud S., Ozgen C., and Billingsley R., Case History: Microseismicity-constrained discrete fracture network models for stimulated reservoir simulation, Geophysics, 78(1), B37-B47, 2013)

One of the characteristics of interest of a microseismic event is its strength, typically quantified by seismic moment or moment magnitude (Shmeta J. and Anderson P., It's a matter of size: Magnitude and moment estimates for microseismic data, The Leading Edge, 29(3), 296-302, 2010). Moment magnitude is proportional to the logarithm of seismic moment and seismic moment is proportional to the shear area of a microseismic source. Therefore, it is important to know the seismic moment of microseismic events for DFN and SRV estimation (See, McKenna J. P. and Toohey N., A magnitude-based calibrated discrete fracture network methodology, First Break, 31(9), 45-54, 2013).

Furthermore, through b-value (“b” representing the Gutenberg-Richter parameter) analysis from the Gutenberg-Richter equation it is possible to distinguish between new fracture creation and reactivating a fault (Wessels S., Kratz M., De La Pena A., Identifying Fault Activation During Hydraulic Stimulation In the Barnett Shale: Source Mechanisms, B Values, And Energy Release Analyses of Microseismicity, SEG 81st Annual Meeting, 1463-1467, 2011). Magnitudes may also be used to determine and avoid sensed seismicity resulting from hydraulic fracturing through a so called “traffic light system” (Green, et al, Preese Hall shale gas fracturing review & recommendations for induced seismic mitigation, Report to UK DECC 2012). Finally, through comparing moment magnitudes between basins, it may possible to avoid hazards as well as optimize completions by statistical magnitude prediction (Freudenreich Y., Oates S. J, Berlang W., Microseismic feasibility studies—assessing the probability of success of monitoring projects, Geophysical Prospecting, Geophysical Prospecting, 60(6), 1043-1053, 2012).

### SUMMARY

A method according to one aspect for estimating moment magnitude of a seismic event occurring in subsurface formations includes measuring seismic signals at each of a plurality of seismic sensors disposed in a selected pattern proximate a subsurface area in which the seismic event occurs. Amplitude events corresponding to the seismic event from the signals detected by each receiver are time aligned. Corrections are applied to the aligned events for density, for the formation velocity, for the radiation pattern, for propagation effects and instrument response. The corrected events are summed. Seismic moment is determined from the summed, corrected events. A moment magnitude is estimated from the seismic moment.

Other aspects and advantages will be apparent from the description and claims that follow.

### BRIEF DESCRIPTION OF THE DRAWINGS

FIG. 1 shows an example of acquiring microseismic event signals according to the disclosure.

FIG. 2 shows a flow chart of an example of processing signals to obtain seismic moment from the acquired signals.

FIG. 3 shows an oblique view of an example seismic sensor arrangement.

FIG. 4 shows a plan view of the example arrangement of FIG. 3

FIG. 5 shows an example of signals recorded on each of the lines of sensors shown in FIG. 4.

FIG. 6 shows the signals of FIG. 5 time aligned along a maximum amplitude of a signal arrival.

FIG. 7 shows the signals of FIG. 6 with corrections applied to obtain true amplitude.

FIG. 8 shows the signals of FIG. 7 summed and divided by the number of signal traces.

FIG. 9 shows a sum or stack of some or all of the traces of FIG. 8.

FIG. 10 shows an integral of the summed trace of FIG. 9, representing a displacement trace.

FIG. 11 shows a log-log plot of frequency with respect to displacement of a Fourier transform of the displacement trace of FIG. 10.

FIG. 12 shows an example computer system that may be used to implement some or all of the example method explained with reference to FIGS. 1 and 2.

### DETAILED DESCRIPTION

The present disclosure provides an example of a method for microseismic event moment magnitude estimation which is based on stacking waveforms and does not require a calibration event.

The strength of microseismic events may be described by a moment magnitude scale introduced in, Hanks T. and Kanamori H., Moment magnitude scale, Journal of Geophysical Research, 84, 2348-2350, BSSA, 1979:

$${M}_{w} = \frac{2}{3} \cdot {log}_{10} {M}_{0} - 6.06 , \qquad ( 1 )$$

in which the seismic moment M₀ [in units of Nm] is a measurable physical quantity directly related to the microseismic event source parameters.

To estimate seismic moment seismologists use recorded waveforms as it has been shown that seismic moment M₀ is proportional to the low frequency limit Ω(0) of the displacement spectrum of seismic traces (Scherbaum, F., Of poles and zeros: Fundamentals of digital seismology, Springer, 2001, p. 201-203):

M₀=Cᵢ·Ω(0)ᵢ, (3)

where the factor Cᵢ (subscript “i” indicates an i-th seismic receiver in a plurality of such receivers) contains corrections for radiation pattern, propagation effects such as spherical divergence, attenuation, transmission, reflection and free surface boundary (if receivers are placed on the surface). Ω(0) can be measured as a double integral of a velocity trace it \dot{u}(t) over time (or a single integral of a displacement trace u(t) over time or triple integral of an acceleration trace ü(t) over time) (See Scherbaum, F., Of poles and zeros: Fundamentals of digital seismology, Springer, 2001, p. 201):

Ω(0)=∫∫\dot{u}(t)dtdt=∫u(t)dt=lim_{f→0}F(u), (4)

where F(u) is the Fourier transform of the trace or signal u. Note that an integral of a trace is also a value of its Fourier transform at zero frequency. Knowing that amplitude spectra of displacement is flat below the corner frequency for a given seismic event, it is possible to use the limit, instead of the value at 0 as described in Eq. (4).

In the simplest implementation, the factor C, can be computed in the following form for a single seismic receiver (see, Aki, K. and Richards, P. [2002] Quantitative seismology, University Science Books, Sausalito, Chapter 10):

$${C}_{i} = 4 \cdot π \cdot ρ \cdot {v}^{3} \cdot \frac{1}{{J}_{i}} \cdot \frac{1}{{R}_{i}} \cdot \frac{1}{{S}_{i}} \cdot \frac{1}{{A}_{i}} \qquad ( 5 )$$

where ρ represents the density, ν represents formation velocity, Jᵢ is a geometrical spreading correction factor, Rᵢ represents the radiation pattern correction, Sᵢ represents the free surface correction (if the receiver is placed on the Earth's surface), and Aᵢ represents the correction for attenuation and dispersion.

Current techniques known in the art for seismic moment measurement of a seismic event include measuring seismic moment on each of the available receivers and then averaging the estimates to yield a seismic moment for a given event:

$${M}_{0} = \frac{1}{N} {\sum }_{i = 1}^{N} {M}_{0 i} .$$

This technique consists of finding the low frequency limit Ω(0) at every receiver according to Eq. (4) and then applying corrections Cᵢ according to Eq. (5):

$$\frac{1}{N} {\sum }_{i = 1}^{N} {M}_{0 i} = \frac{1}{N} {\sum }_{i = 1}^{N} ( {C}_{i} \cdot \int \int \dot{u} ( t ) d t d t ) . \qquad ( 6 )$$

A method for obtaining seismic moment based on stacking waveforms recorded with a plurality of receivers according to the present disclosure includes first applying the corrections to receiver traces and then summing the corrected traces. Next, double integration of the averaged waveforms is performed, which is equal to the seismic moment for a given seismic event:

$${M}_{0} = \int \int ( \frac{1}{N} {\sum }_{i = 1}^{N} [ {C}_{i} \cdot \dot{u} ( t ) ] ) d t d t . \qquad ( 7 )$$

Double integration of an average waveform in Eq. (7) may be replaced with the low frequency limit of its Fourier transform as in Eq. (4). Moment magnitude may then be calculated using the resulting seismic moment with Eq. (1).

Equations (3) and (4) show explicitly that according to scientific theory seismic moment cannot be obtained from unprocessed velocity or displacement seismogram traces, but the traces to be integrated once or twice. Nevertheless, it is known in the art to approximate moment from some other function of seismic velocity or displacement (see, Zhou, R., Huang, G., Snelling, P., Thornton, M., Mueller, M. [2013] Magnitude calibration for microseismic events from hydraulic fracture monitoring, 83rd SEG Annual Meeting, 2145-2149). Therefore, it is possible to construct a function in which seismic moment M₀ is proportional to merely sum of true, corrected seismic amplitudes:

$${M}_{0} ∼ \frac{1}{N} {\sum }_{i = 1}^{N} [ {C}_{i} \cdot \dot{u} ( t ) ] . \qquad ( 8 )$$

Stacking the traces in Eq. (7) may be performed along the moveout indicated by first arrival times of P- or S-waves and integration should be applied over a period of time representative of the detected seismic signal.

Traces which are used for moment magnitude estimation, prior to integration, should be corrected for the instrument response, i.e., they must represent true ground motion within the frequency range of interest.

There are various instruments used for recording seismic signals. For example, surface microseismic monitoring typically uses vertical geophones with 10 Hz resonance/cut-off frequency. Using 10 Hz geophones makes estimation of Ω(0) difficult for microearthquakes of corner frequencies at and below this frequency for events with Mw>1 (See, Eisner, et al, The peak frequency of direct waves for microseismic events, Geophysics, 78(6), A45-A49 2013). However, in practice, corner frequencies are almost always higher than the cut-off frequencies for typical applications of microseismic monitoring (i.e. at Mw<0). For this reason, one may estimate Ω(0) from the plateau level of the displacement spectrum as shown in Scherbaum, F., Of poles and zeros: Fundamentals of digital seismology, Springer, 2001, pp. 202-203).

Having explained the principle of an example method according to the disclosure, an example implementation will now be explained.

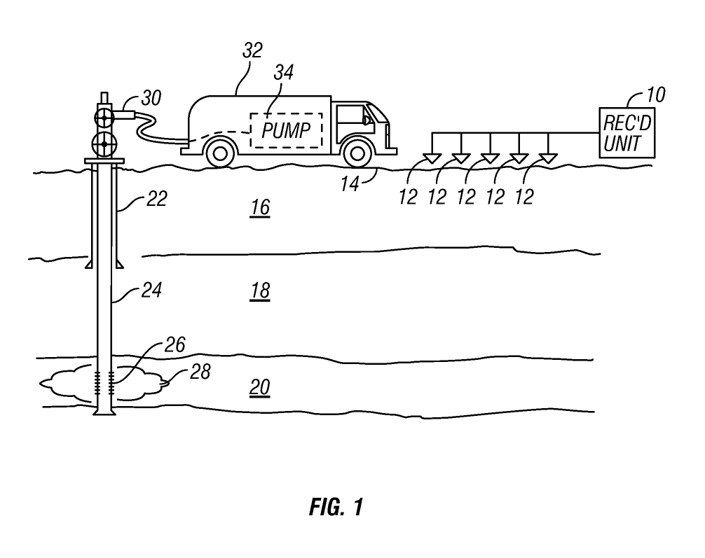

FIG. 1 shows a wellbore 22 drilled through subsurface formations 16, 18, 20. In this example, one of the subsurface formations, shown at 20 can be a hydrocarbon producing formation. A wellbore tubing 24 including perforations 26 for receiving fluid from the hydrocarbon producing formation 20 is deployed in the wellbore 22. The wellbore tubing 24 is connected to a surface wellhead 30 including an assembly of valves (not indicated separately) for controlling fluid flow. The wellhead 30 may be hydraulically connected to a pump 34, which may be a component of a “fracture pumping unit” 32. The fracture pumping unit 32 may be used to pump fluid down the wellbore 22 and into the subsurface formations, particularly the hydrocarbon producing formation 20, in a well process. i.e., hydraulic fracturing. For illustration purposes, the movement of fluid into the hydrocarbon producing formation 20 is indicated by the fluid front 28. In hydraulic fracturing, the fluid is pumped into the hydrocarbon producing formation 20 at a pressure which exceeds the fracture pressure of the hydrocarbon producing formation 20, causing the hydrocarbon producing formation 20 to rupture and develop fissures. The fracture pressure is generally related to the overburden pressure, i.e., the pressure exerted by the weight of all the formations above the hydrocarbon producing formation. The fluid pumped into the hydrocarbon producing formation 20 may include proppant, i.e., solid particles having a selected size. In propped fracturing operations, the particles of the proppant move into fissures formed in the hydrocarbon producing formation 20 and remain in the fissures after the fluid pressure is reduced below the fracture pressure of the formation, thereby propping the fissures open for subsequent fluid production from the hydrocarbon producing formation. Hydraulic fracturing with proppant has the effect of increasing the effective radius of the wellbore 22 that is in hydraulic communication with the hydrocarbon production formation 20, thus substantially increasing the productive capacity of the wellbore 22.

FIG. 1 shows an array of seismic sensors 12 arranged proximate to the Earth's surface 14 to detect seismic energy originating from within one or more the subsurface formations 16, 18, 20. In marine applications, the array of seismic sensors 12 could be arranged at or proximate to the water bottom in a cable-based device known as an “ocean bottom cable.” The seismic sensors 12 detect seismic energy created, for example, by hydraulic fracturing of the hydrocarbon producing formation 20. The seismic energy may also result from other seismic events occurring within the Earth's subsurface, for example, microearthquakes.

In some examples, the seismic sensors 12 may be arranged in sub-groups, with spacing between individual sensors in each of the sub-groups being less than about one-half the expected wavelength of seismic energy from the Earth's subsurface that is intended to be detected. Signals from all the seismic sensors 12 in one or more of the sub-groups may be added or summed to reduce the effects of noise in the detected signals. The seismic sensors 12 generate electrical or optical signals in response to particle motion, velocity or acceleration. A recording unit 10 is in signal communication with the seismic sensors 12 for making a time-indexed recording of the seismic signals detected by each seismic sensors 12. In some examples the seismic sensors 12 are geophones. In other examples, the seismic sensors 12 may be accelerometers or other sensing devices known in the art that are responsive to motion, velocity or acceleration, of the formations proximate to the particular sensor. Some types of seismic sensors may include a plurality of mutually orthogonally arranged particle motion responsive sensing elements to detect particle motion along different directions, e.g., shear waves. Accordingly, the type of seismic sensor is not a limit on the scope of the present invention.

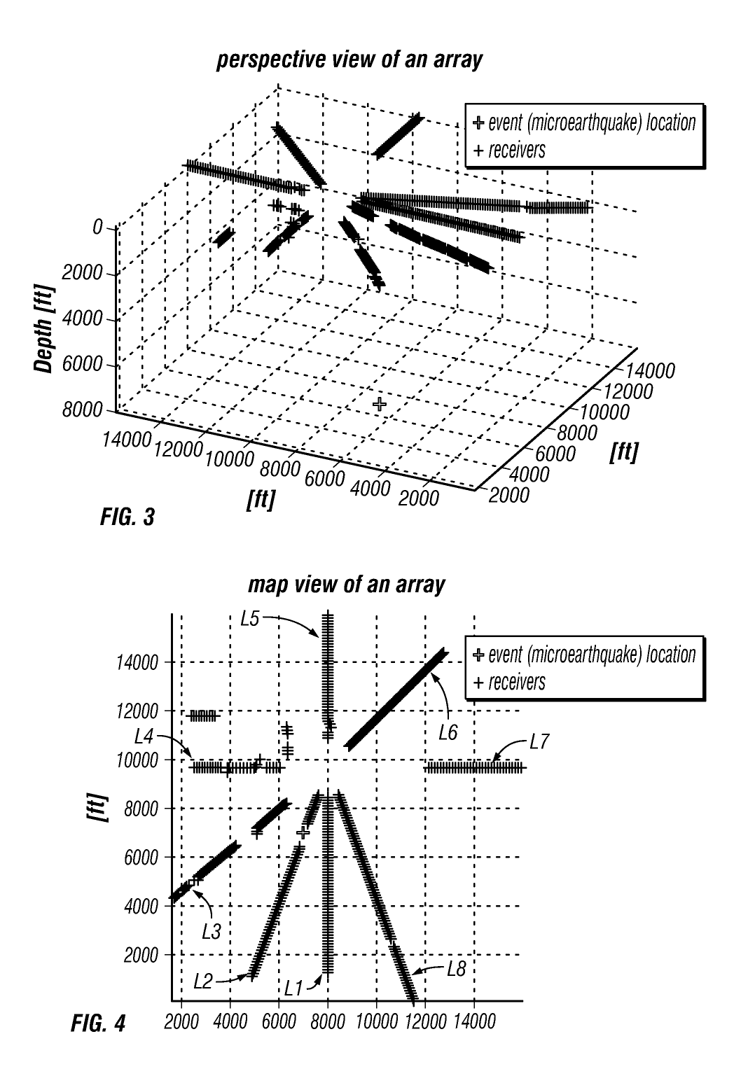

In one example, the seismic sensors 12 may be arranged in a radially extending, spoke like pattern, with the center of the pattern disposed approximately about the surface position of the wellbore 22. Alternatively, if the geodetic position of the formations at which the fluid enters from the wellbore is different than the surface geodetic position of the wellbore 22, the sensor pattern may be centered about such geodetic position. Such sensor pattern is used in fracture monitoring services provided under the service mark FRACSTAR, which is a registered service mark of Microseismic, Inc., Houston, Tex., also the assignee of the present invention. Examples of arrangements of the seismic sensor pattern are shown in perspective view in FIG. 3, and in plan view in FIG. 4 along a plurality of lines L1 through L8.

The foregoing example of arranging sensors in a selected pattern on the surface is only one example of an arrangement for acquiring seismic signals usable with methods according to the present disclosure. It is also possible to one or more place seismic sensors at selected depths in one or more wellbores in the vicinity of the area of the Earth's subsurface to be evaluated using example methods as described herein. For example, one arrangement of sensors is described in U.S. Patent Application Publication No. 2011/024934 filed by Thornton et al. Other arrangements of seismic sensors will occur to those skilled in the art. For purposes of acquiring seismic signals for use with the present example methods, it is preferable that the seismic sensors be proximate the spatial position of the seismic events giving rise to the detected signals. Proximate in the present context may mean up to about 10 kilometers from the seismic events.

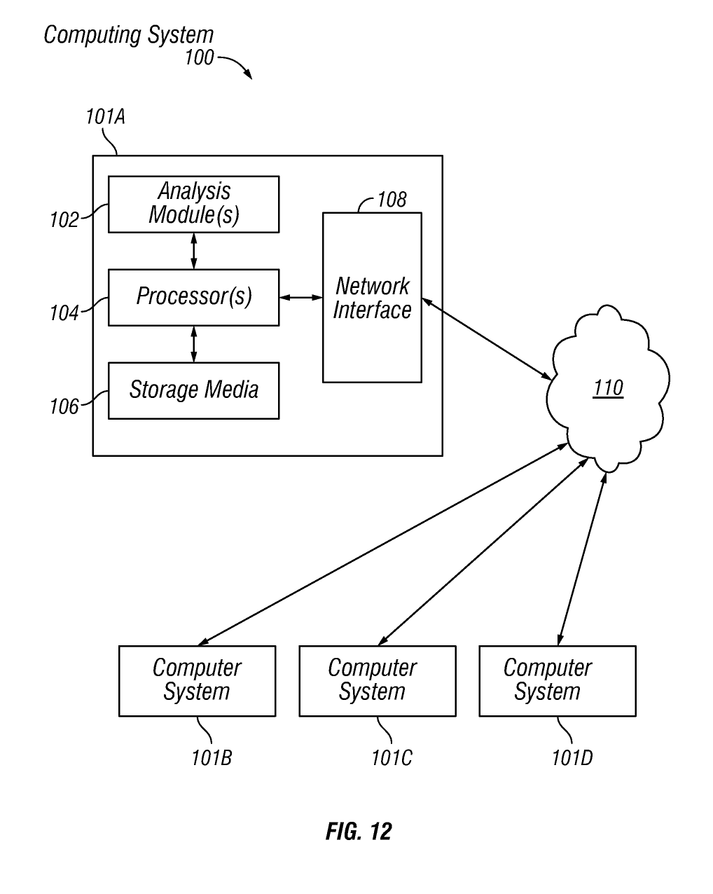

The recording unit 10 may include (not shown separately) a general purpose programmable computer or a dedicated program computer including data storage and display devices that may perform a process according to the present invention and store and/or display the results of the process. The type of computer used to implement the method and the type of display and/or storage devices are not limits on the scope of the present invention. An example computer system operable at multiple locations will be explained with reference to FIG. 12.

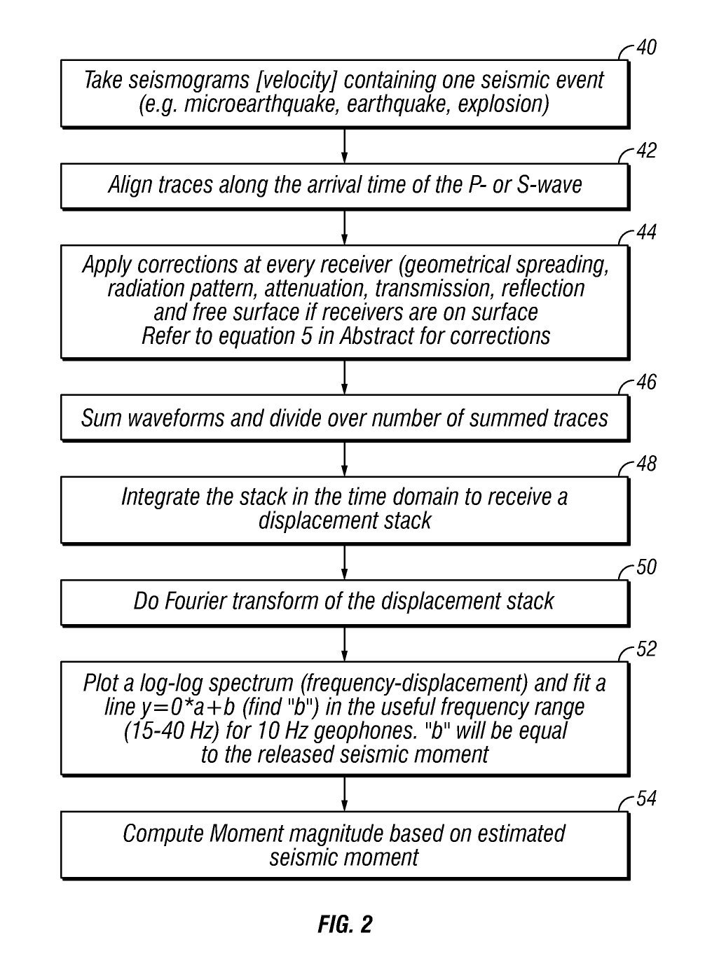

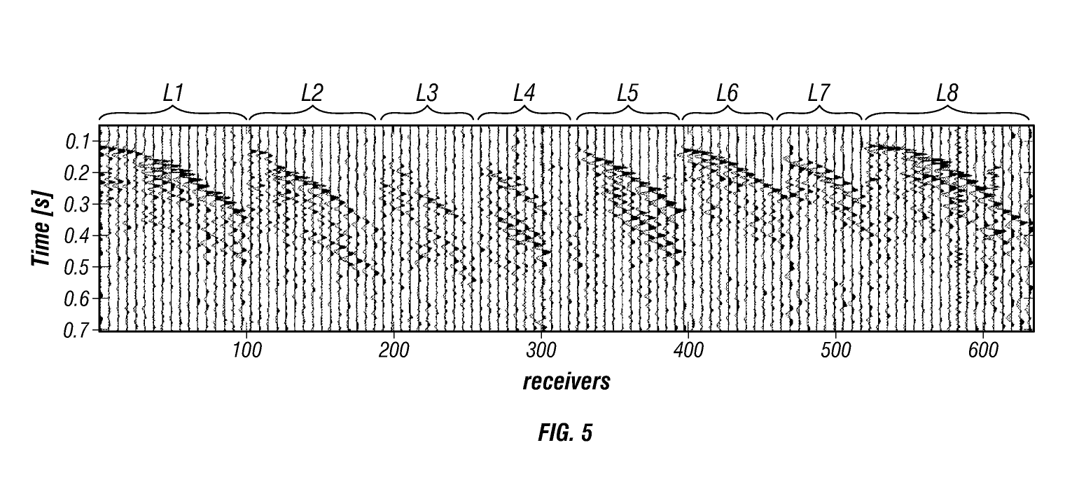

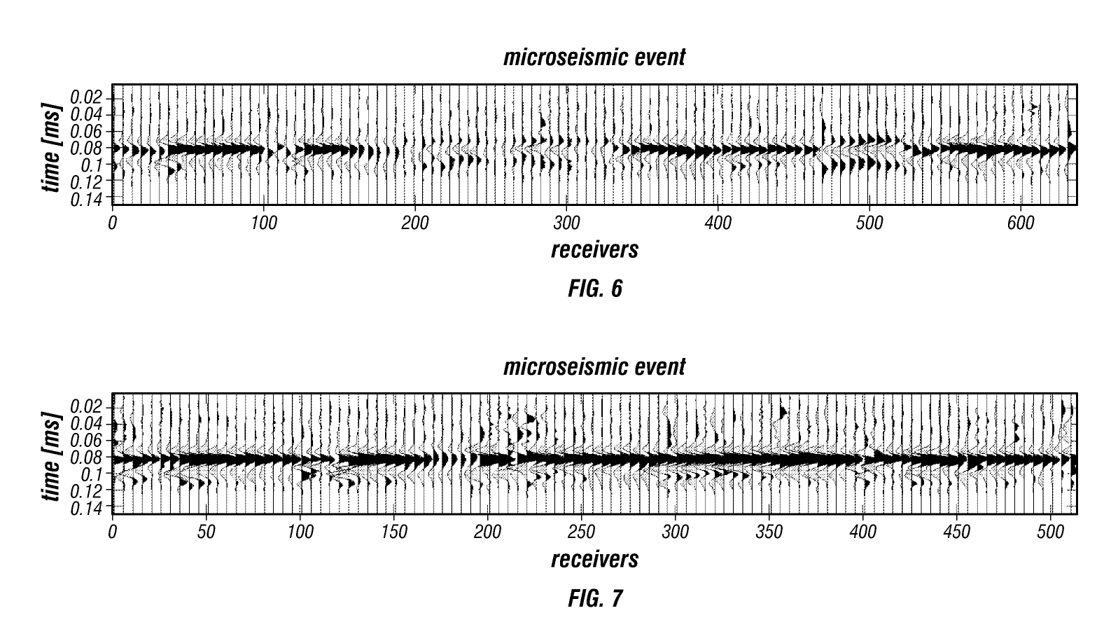

Having acquired seismic signals originating in the subsurface, an example method for processing the signals will be explained with reference to the flow chart in FIG. 2. At 40, seismic signals are recorded at each sensor corresponding to one or more microseismic events, as shown in and explained with reference to FIG. 1. At 42, the seismic signal recordings from each seismic sensor may be displayed or processed as traces (i.e., the signal amplitude from the seismic sensors with respect to time). The traces may be aligned so that a maximum amplitude in each trace corresponding to a particular microseismic event is time coincident with the maximum amplitudes of the same microseismic event present in each of the other traces. Time alignment may be performed by visual observation of the traces and manually selecting corresponding amplitude events in each of the traces, or may be performed automatically in the computer system, e.g., by selecting an amplitude threshold. FIG. 5 shows the traces as recorded from each seismic sensor along each one of the lines L1-L8 shown in FIG. 4. FIG. 6 shows the traces after alignment.

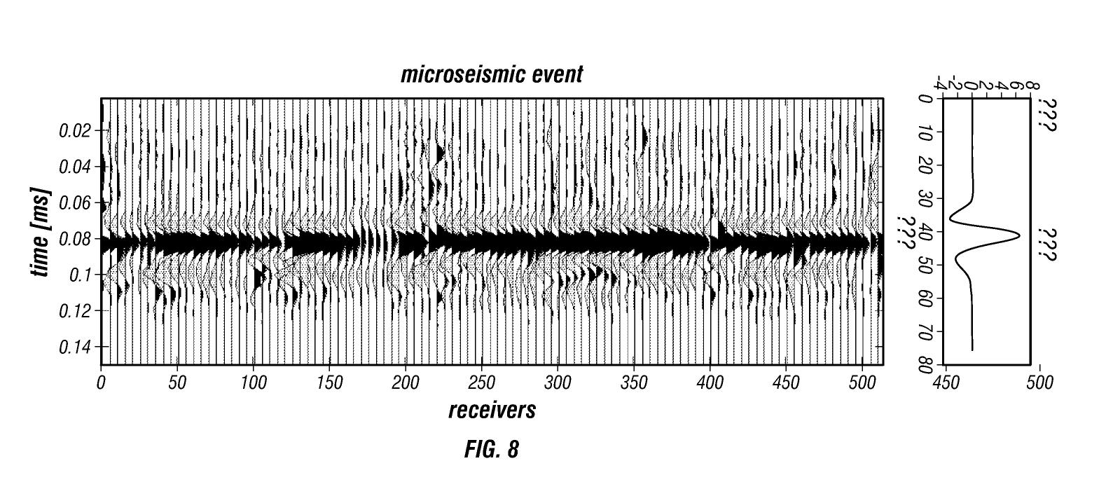

At 44, corrections to each of the traces in FIG. 6 are applied as described with reference to Eq. (5): ρ for the density at the source, ν for the formation velocity at the source, Jᵢ for geometrical spreading, Rᵢ for the radiation pattern, Sᵢ for the free surface correction, and Aᵢ for correction for attenuation. The corrected traces are shown in FIG. 7. At 46, the corrected traces are summed and divided by the total number of traces. An example display of such summed and divided traces is shown in FIG. 8.

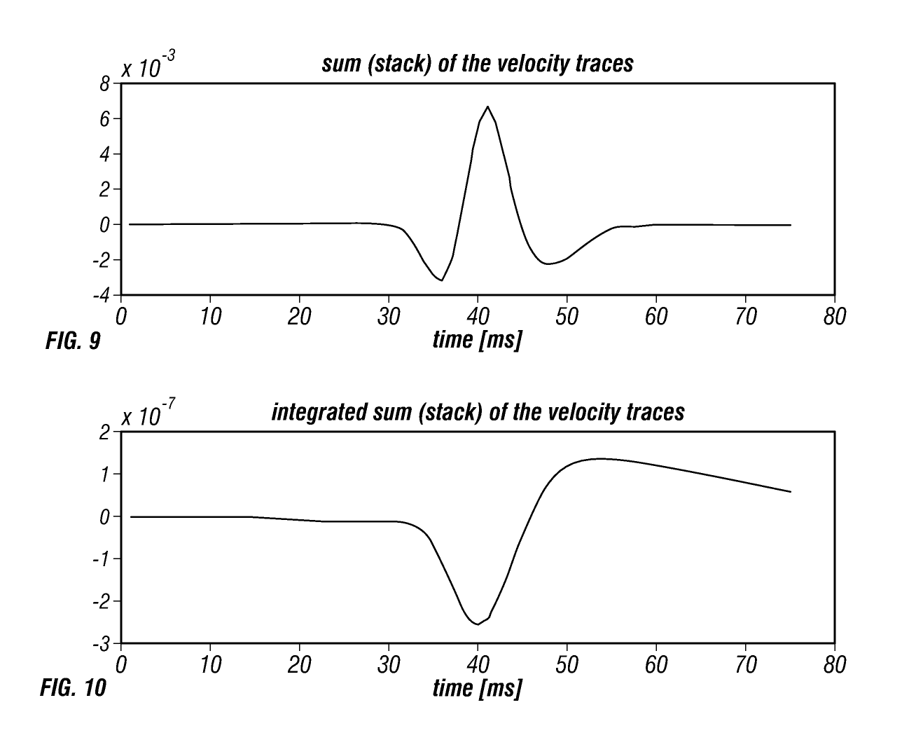

The summed trace is shown in FIG. 9 representing velocity with respect to time. At 48, the summed velocity trace is integrated with respect to time, providing a trace of displacement with respect to time. The integrated velocity trace is shown in FIG. 10.

Some function of the summed trace shown in FIG. 9 may be used as an approximation of the seismic moment. For example, a peak amplitude divided by the square of the peak frequency, or integration of the energy in the summed trace may be used as an approximation of the seismic moment. The present example may use integration of the traces into displacement traces and detailed analysis thereof as described below.

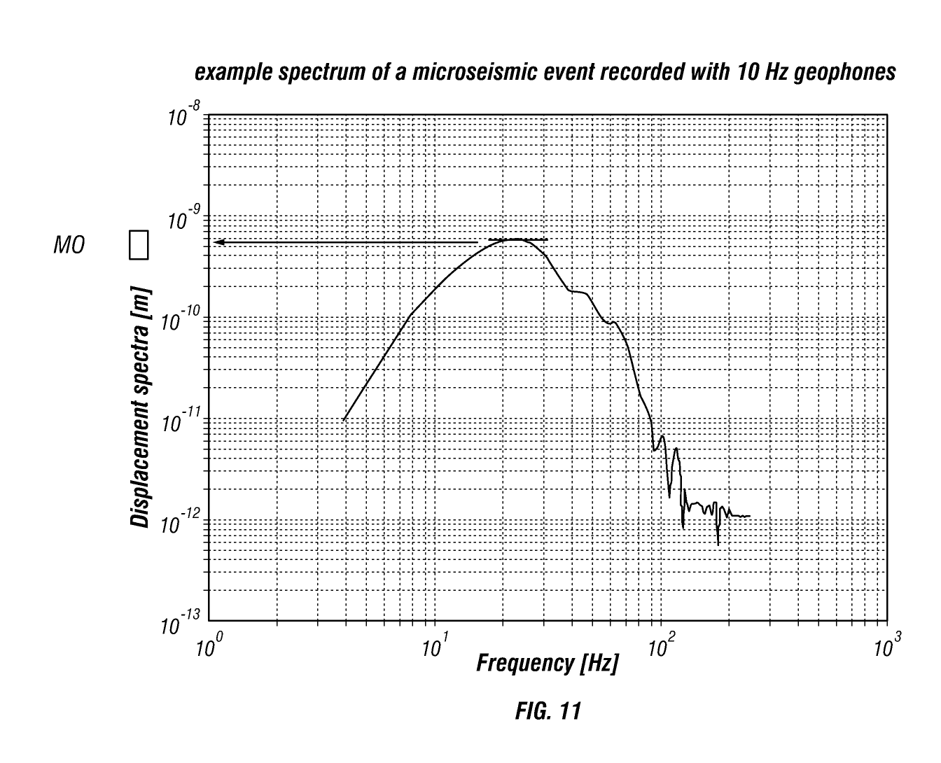

At 50, the integrated velocity trace shown in FIG. 10 may be Fourier transformed to provide a frequency-displacement curve. Such a curve is shown in a logarithmic scale-logarithmic scale plot in FIG. 11. The amplitude plateau of the displacement (y-axis) of the curve in FIG. 11 can be used as approximation of the value of the released seismic moment “M₀.” At 52, a value of the moment magnitude may be computed from the value of M₀ using Eq. (1).

FIG. 12 depicts an example computing system 100 in accordance with some embodiments. The computing system 100 may be an individual computer system 101A or an arrangement of distributed computer systems The computer system 101A may be disposed in the recording unit (10 in FIG. 1). The computer system 101A may include one or more analysis modules 102 that may be configured to perform various tasks according to some embodiments, such as the tasks depicted in FIG. 2. To perform these various tasks, analysis module 102 may execute independently, or in coordination with, one or more processors 104, which may be connected to one or more storage media 106. The processor(s) 104 may also be connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well drilling location, while in communication with one or more computer systems such as 101C and/or 101D that may be located in one or more data centers on shore, aboard ships, and/or located in varying countries on different continents).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the exemplary embodiment of FIG. the storage media 106 are depicted as within computer system 101A, in some embodiments, the storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above may be provided on one computer-readable or machine-readable storage medium, or alternatively, can be provided on multiple computer-readable or machine-readable storage media distributed in a large system having possibly plural nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the example embodiment of FIG. 12, and/or computing system 100 may have a different configuration or arrangement of the components depicted in FIG. 12. The various components shown in FIG. 12 may be implemented in hardware, software, or a combination of both hardware and software, including one or more signal processing and/or application specific integrated circuits.

Further, the steps in the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for estimating seismic moment of a seismic event occurring in subsurface formations, comprising:
measuring seismic signals at each of a plurality of seismic sensors disposed in a selected pattern proximate a subsurface area in which the seismic event occurs;
in a computer, aligning waveforms corresponding to the seismic event from the signals detected by each receiver;
in the computer correcting the aligned waveforms for density, for formation velocity, for radiation pattern, for propagation effects and for instrument response;
in the computer summing the corrected waveforms;
in the computer, determining a seismic moment from the summed corrected waveforms; and
estimating a moment magnitude from the seismic moment.

2. The method of claim 1 wherein the seismic moment is determined by:
in the computer, integrating the summed corrected waveforms to obtain a displacement trace;
in the computer, performing a Fourier transform on the displacement trace; and
determining the seismic moment from a spectrum plateau of the transformed displacement trace.

3. The method of claim 1 wherein the seismic event comprises a hydraulically induced fracture.

4. The method of claim 1 wherein the seismic signals comprise velocity signals.

5. The method of claim 1 wherein the seismic moment is determined from stacked waveforms.

6. The method of claim 2 wherein integration of the summed corrected waveforms is approximated by a plateau at low a frequency limit of the Fourier transform of the summed corrected waveforms.

7. A method for estimating moment magnitude of a seismic event occurring in subsurface formations, comprising:
entering as input to a computer recorded measurements of seismic signals from each of a plurality of seismic sensors disposed in a selected pattern proximate a subsurface area in which the seismic event occurs;
in the computer, aligning waveforms corresponding to the seismic event from the recorded measurements;
in the computer correcting the aligned waveforms for density, for formation velocity, for radiation pattern, for propagation effects and for instrument response;
in the computer summing the corrected waveforms;
determining seismic moment from summed waveforms; and
estimating a moment magnitude from the seismic moment.

8. The method of claim 7 wherein the seismic moment is determined by:
in the computer, integrating the summed corrected waveforms to obtain a displacement trace;
in the computer, performing a Fourier transform on the displacement trace; and
determining the seismic moment from a spectrum plateau of the transformed displacement trace.

9. The method of claim 7 wherein the seismic event comprises a hydraulically induced fracture.

10. The method of claim 7 wherein the seismic signals comprise velocity signals.

11. The method of claim 7 wherein the seismic moment is determined from stacked waveforms.

12. The method of claim 8 wherein integration of the summed corrected waveforms is approximated by a plateau at low a frequency limit of the Fourier transform of the summed corrected waveforms.

13. A non-transitory computer readable medium having thereon logic operable to cause a programmable computer to perform actions, comprising:
accepting as input to the computer recorded measurements of seismic signals from each of a plurality of seismic sensors disposed in a selected pattern proximate a subsurface area in which the seismic event occurs;
aligning waveforms corresponding to the seismic event from the recorded measurements;
correcting the aligned waveforms for density, for formation velocity, for radiation pattern, for propagation effects and for instrument response;
summing the corrected waveforms;
determining seismic moment from summed waveforms; and
estimating a moment magnitude from the seismic moment.

14. The non-transitory computer readable medium of claim 13 wherein the seismic moment is determined by:
integrating the summed corrected waveforms to obtain a displacement trace;
performing a Fourier transform on the displacement trace; and
determining the seismic moment from a spectrum plateau of the transformed displacement trace.

15. The non-transitory computer readable medium of claim 14 wherein the seismic event comprises a hydraulically induced fracture.

16. The non-transitory computer readable medium of claim 14 wherein the seismic signals comprise velocity signals.

17. The non-transitory computer readable medium of claim 14 wherein the seismic moment is determined from stacked waveforms.

18. The non-transitory computer readable medium of claim 17 wherein integration of the summed corrected waveforms is approximated by a plateau at low a frequency limit of the Fourier transform of the summed corrected waveforms.
